(19) United States
(12) Patent Application Publication
(10) Pub. No.: US 2009/0251470 A1
(43) Pub. Date: Oct. 8, 2009

(54) System and method for compressing a picture

(75) Inventors: Seung Wook Lee, Daejeon (KR); Bon Ki Koo, Daejeon (KR); Ji Hyung Lee, Daejeon (KR); Jin Seo Kim, Daejeon (KR); Chang Woo Chu, Daejeon (KR); Ho Won Kim, Daejeon (KR); Seungtaik Oh, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/289,170

(22) Filed: Oct. 22, 2008

(30) Foreign Application Priority Data
Dec. 11, 2007 (KR) 10-2007-0128077

(51) Int. Cl. G06T 13/00; H04N 7/26

(52) U.S. Cl. 345/473; 375/240.16

(57) ABSTRACT

A system for compressing a picture includes: an information extraction unit for extracting information needed for encoding during a picture scene composition and animation process using a modeling object; and a rendering unit for generating an uncompressed picture sequence by rendering the object where the picture scene composition and animation process is performed. Further, the system for compressing a picture includes an encoding unit for generating a compressed bit stream by encoding the picture sequence from the rendering unit based on the information extracted by the information extraction unit.

### CROSS-REFERENCE TO RELATED APPLICATIONS

The present invention claims priority of Korean Patent Application No. 10-2007-0128077, filed on Dec. 11, 2007, which is incorporated herein by reference.

### FIELD OF THE INVENTION

The present invention relates to a system and method for compressing a picture by using production information of the picture.

This work was supported by the IT R&D program of MIC/IITA [2005-S-082-03, Development of Non-Photorealistic Animation Technology].

### BACKGROUND OF THE INVENTION

Recently, computer graphic techniques have been widely used and, in particular, computer graphic techniques have been necessarily used in lately made movies.

Some movies were made by only using 3D computer graphics, whereas some movies were made by combining realistic images and computer graphics.

In case of the movies made by using computer graphics, a 3D mesh model is made, animation information is inserted by authoring tools such as 3D Max, Maya and the like and then each frame is rendered by various methods. Each still picture sequence rendered in this way is converted into motion pictures by using general video codec such as MPEG-2, MPEG-4, H.264 or WMV.

In case of the conventional method that converts the still pictures to which computer graphics have been applied into motion pictures by using the video codec, there is a problem that picture quality is degraded and generation of motion pictures takes time due to not using production information of the pictures.

For example, although a picture is created by rendering reflection characteristics of a material of a model with a Ray Tracing method, the conventional codec does not recognize this information so that this information is not used in the encoding.

Further, even though the motion of each character is defined by an authoring tool such as 3D Max or Maya in movie production, the conventional codec which does not use production information of the pictures has to calculate motion information for each macro-block or each block of every frame, which results in a longer time.

However, in accordance with the present invention, production information used in producing pictures is used to compress and restore the rendered pictures.

### SUMMARY OF THE INVENTION

In accordance with a first aspect of the present invention, there is provided a system for compressing a picture including: an information extraction unit for extracting information needed for encoding during a picture scene composition and animation process using a modeling object; a rendering unit for generating an uncompressed picture sequence by rendering the object where the picture scene composition and animation process is performed; and an encoding unit for generating a compressed bit stream by encoding the picture sequence from the rendering unit based on the information extracted by the information extraction unit.

In accordance with a second aspect of the present invention, there is provided a method for compressing a picture including: extracting information needed for encoding during a picture scene composition and animation process using a modeling object; generating an uncompressed picture sequence by rendering the object where the picture scene composition and animation process is performed; and generating a compressed bit stream by encoding the picture sequence based on the extracted information needed for the encoding.

In accordance with the present invention, by extracting production information of the picture which is necessary for encoding when an uncompressed picture sequence based on CG techniques is generated and further by applying this information to the encoding for generating a compressed video file, encoding time can be reduced and the quality of the video file can also be improved.

### BRIEF DESCRIPTION OF THE DRAWINGS

The objects and features of the present invention will become apparent from the following description of embodiments given in conjunction with the accompanying drawings, in which:

FIG. 1 is a block diagram of a system for compressing a picture using production information of the picture in accordance with the embodiment of the present invention; and

FIG. 2 is a drawing for describing a process for extracting production information of pictures when a picture sequence is generated in accordance with the embodiment of the present invention.

### DETAILED DESCRIPTION OF THE EMBODIMENTS

Hereinafter, embodiments of the present invention will be described in detail with reference to the accompanying drawings. In the embodiments of the present invention, production information of the picture needed in encoding is extracted when an uncompressed picture sequence made by CG techniques is generated and then the information is applied to an encoding process for generating a compressed video file.

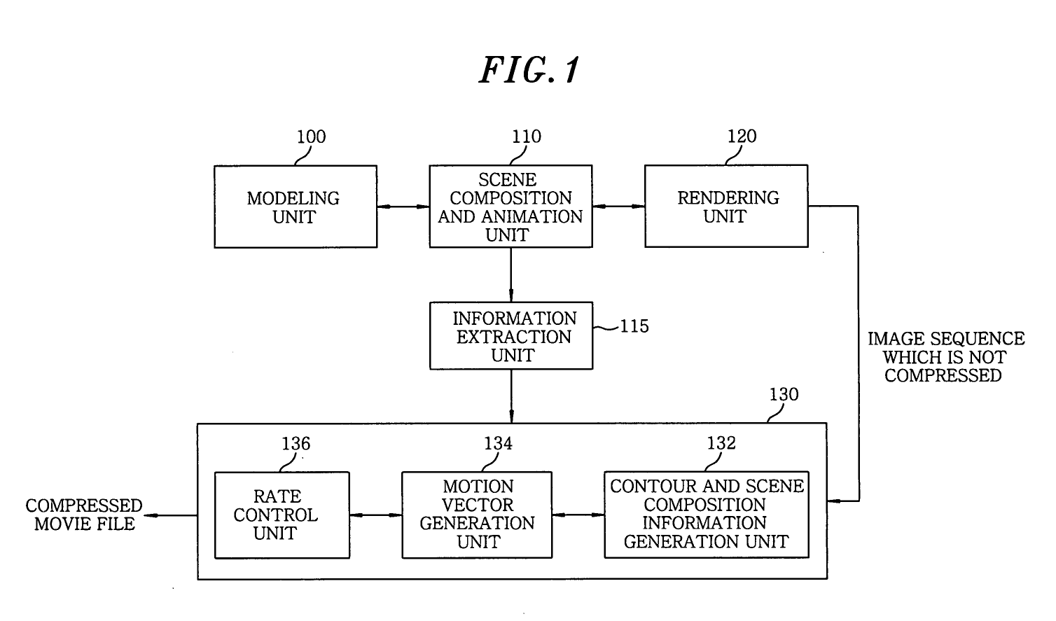

FIG. 1 is a block diagram of a system for compressing a picture using production information of the picture in accordance with the embodiment of the present invention.

Referring to FIG. 1, the system for compressing a picture includes a modeling unit 100, a scene composition and animation unit 110, an information extraction unit 115, a rendering unit 120 and an encoding unit 130.

The modeling unit 100 is a unit for modeling a 3d object such as 3D Max or Maya and modeling data is transmitted to the scene composition and animation unit 110.

The scene composition and animation unit 110 forms a picture scene with the modeling data obtained by using the conventional tool such as 3D max or Maya and performs an animation process. Then, the result data is fed to the rendering unit 120.

The information extraction unit 115 extracts production information of pictures, i.e. information that the encoding unit 130 requires such as contour or scene composition information of the object, motion information of each object and rendering information based on light, while composing a scene by using the modeling data and performing the animation process. Then, it provides the information to the encoding unit 130.

The information extraction unit 115 is inserted as a plug-in into the scene composition and animation unit 110.

The rendering unit 120 generates an uncompressed picture sequence by rendering the data from the scene composition and animation unit 110 using a renderer such as RenderMan, Mental Ray or the like and transmits it to the encoding unit 130.

The encoding unit 130 generates a compressed bit stream, e.g., a compressed video file, by encoding the picture sequence from the rendering unit 120 using the information supplied from the information extraction unit 115. The encoding unit 130 includes a contour and scene composition information generation unit 132, a motion vector generation unit 134 and a rate control unit 136.

The contour and scene composition information generation unit 132 generates a contour and scene composition information of the object necessary for the MPEG-4 object-based encoding. It converts the information supplied from the information extraction unit 115, i.e. contour and scene composition information, into a video file format outputted from the encoding unit 130, e.g. an MPEG-4 standard format in case of object-based encoding. That is, the contour and scene composition information generation unit 132 forms a binary format for scenes (hereinafter, referred to as a “BIFS”) for picture segmentation and scene composition by using the contour and scene composition information supplied from the information extraction unit 115.

The motion vector generation unit 134 generates motion vectors for use in hybrid coding denoted as MPEG-x and H.26× and it converts the motion information of each object from the information extraction unit 115 into the file format outputted from the encoding unit 130.

The rate control unit 136 for controlling the rate of the hybrid coding denoted as MPEG-x and H.26 xdetermines which part has more bits according to the file format outputted from the encoding unit 130 by using the rendering information based on light from the information extraction unit 115.

In general, the rate control unit 136 calculates the number of bits to be assigned to each basic unit, e.g., each macro block, through Rate-Distortion Optimization (R-D Optimization) in order to control the rate. In the present invention, the rate control unit 136 calculates the number of bits to be assigned to each basic unit, e.g., each macro block, by using the rendering information based on light.

In the encoding unit 130, the contour and scene composition information of the object in the MPEG-4 standard format are inserted into the compressed bit stream, the motion information of the object extracted by the information extraction unit 115 is converted into various types of the motion vectors and then inserted into the compressed bit stream, and bits are adaptively assigned to each part depending on the rendering information based on light, thereby performing encoding.

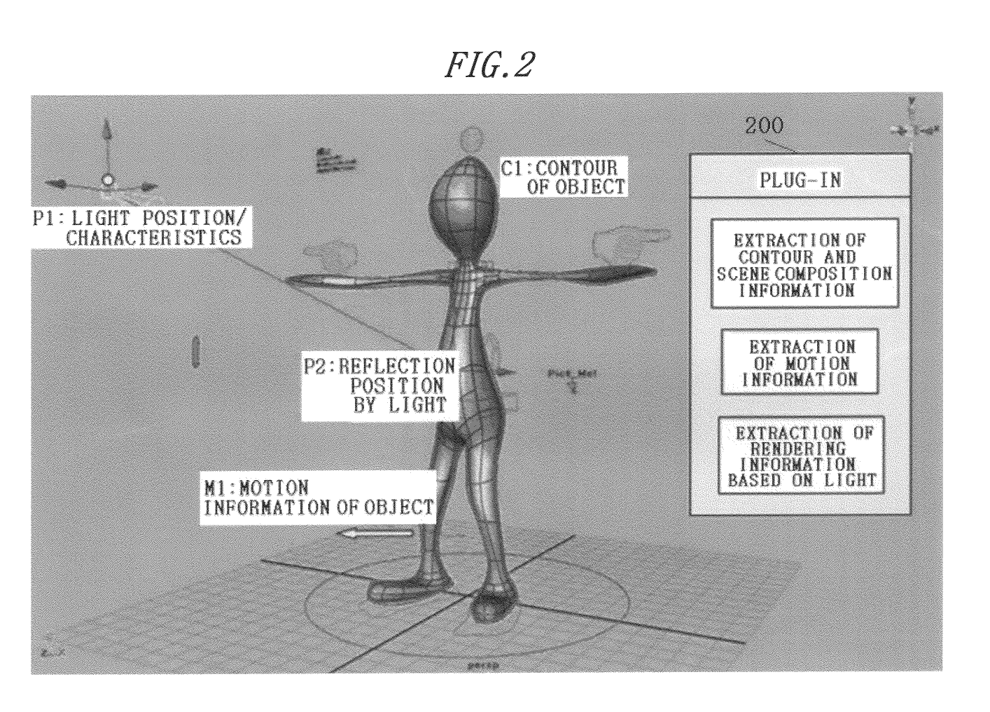

Hereinafter, a method for producing a CG based picture, e.g., full animation such as an animated film “Cars” produced by Pixar or a CG picture combined with the real image such as “The Lord of the Rings”, by using the system for compressing a picture of the present invention configured as described above will be described with reference to FIG. 2.

First, a producer creates modeling data by modeling each object with the conventional modeling tool such as the modeling unit 100, which are fed to the scene composition and animation unit 110.

The scene composition and animation unit 110 composes a scene with the modeling data and performs an animation process. At that time, the information extraction unit 115 extracts information necessary for the encoding.

The information extraction process will be described in detail as follows.

The information extraction unit 115 has a plug-in menu layout 200 as shown in FIG. 2. During the scene composition and animation process by using Maya, if extraction of contour and scene composition information is selected from the plug-in menu 200 by clicking the button, contour information of the object (character) C1 is extracted. If extraction of motion information is selected, motion information of the object M1 is extracted.

Further, if extraction of rendering information based on light is selected from the plug-in menu 200, light position and characteristics of the current scene, related rendering parameters, position according to the rendering result and the like are extracted. The information extracted here is stored in a file and provided to the encoding unit 130.

After that, the rendering unit 120 generates an uncompressed picture sequence by rendering the scene composition and animation result with the conventional renderer.

The encoding unit 130 converts the information received from the information extraction unit 115 into an encoding format such as MPEG-x, H.26× or the like. Based on this, the encoding unit 130 creates a compressed bit stream, e.g., a compressed video file with the uncompressed picture sequence.

Since picture segmentation is needed for the MPEG-4 object-based encoding of the encoding unit 130, the contour and scene composition information generation unit 132 of the encoding unit 130 converts the contour and scene composition information of the object extracted by the information extraction unit 115 into the information format defined in MPEG-4.

Furthermore, the motion vector generation unit 134 generates motion vectors in the conventional standard format on the basis of the motion information of each object extracted by the information extraction unit 115. That is, the motion vector generation unit 134 generates a variety of motion vectors, e.g., 16×16, 16×8, 8×16, 8×8, 8×4, 4×8 and 4×4, like the motion vectors generated by the conventional standard codec by using the motion information M1 from the information extraction unit 115.

In the present invention, by converting the motion information M1 from the information extraction unit 115 into the motion vectors conforming to the conventional standard format as described above, accurate motion vectors can be obtained without executing complicated calculation.

The rate control unit 136 determines the number of bits to be assigned to each position in the picture by using the information from the information extraction unit 115, i.e. light position and characteristics information P1 and reflection position by light P2 shown in FIG. 2, where more bits are assigned to the reflection position by light P2.

Generally, the rendering unit 120 renders the surface texture of the object by using P1, P2, rendering information based on light, BRDF (Bidirectional Reflectance Distribution Function) and a Ray Tracing method. That is, the reflection position by light P2 is given a greater weight on the rendering of the rendering unit 120, which is notified to the rate control unit 136, so that the rate control unit 136 can assign more bits to the reflection position by light P2.

By assigning more bits to the rendering part which the rendering unit 120 has focused on, a compressed video file which is more realistically encoded can be produced.

While the invention has been shown and described with respect to the embodiments, it will be understood by those skilled in the art that various changes and modifications may be made without departing from the scope of the invention as defined in the following claims.

What is claimed is:

1. A system for compressing a picture comprising:
an information extraction unit for extracting information needed for encoding during a picture scene composition and animation process using a modeling object;
a rendering unit for generating an uncompressed picture sequence by rendering the object where the picture scene composition and animation process is performed; and
an encoding unit for generating a compressed bit stream by encoding the picture sequence from the rendering unit based on the information extracted by the information extraction unit.

2. The system of claim 1, wherein the encoding unit converts the information extracted by the information extraction unit into a compressed bit stream format and encodes the picture sequence generated from the rendering unit by using the converted information.

3. The system of claim 1, wherein the information extraction unit extracts at least one of contour information, scene composition information and motion information of the object and rendering information based on light as the information needed for the encoding.

4. The system of claim 3, wherein the encoding unit includes a scene composition and contour information generation unit for converting the contour and scene composition information of the object into the compressed bit stream format;
a motion vector generation unit for generating motion vectors by converting the motion information of the object into the compressed bit stream format; and
a rate control unit for determining the number of bits to be assigned to each part in a picture of the picture sequence based on light information and the rendering information based on light, encoding of the picture sequence being performed by adaptively applying information generated from the scene composition and contour information generation unit, the motion vector generation unit and the rate control unit.

5. The system of claim 4, wherein the scene composition and contour information generation unit forms a BIFS (Binary Format For Scenes) for picture segmentation and scene composition by using the contour and scene composition information of the object.

6. The system of claim 4, wherein the rendering information based on light includes at least one of light position and characteristics for each scene, reflection position by the light and a rendering parameter for the light.

7. A method for compressing a picture comprising:
extracting information needed for encoding during a picture scene composition and animation process using a modeling object;
generating an uncompressed picture sequence by rendering the object where the picture scene composition and animation process is performed; and
generating a compressed bit stream by encoding the picture sequence based on the extracted information needed for the encoding.

8. The method of claim 7, wherein generating a compressed bit stream further includes converting the extracted information into a compressed bit stream format, the compressed bit stream being generated by encoding the picture sequence using the converted information.

9. The method of claim 7, wherein the information needed for the encoding includes at least one of contour information, scene composition information and motion information of the object and rendering information based on light as the information needed for the encoding.

10. The method of claim 9, wherein generating a compressed bit stream further includes:
converting the contour and scene composition information of the object into the compressed bit stream format;
generating motion vectors by converting the motion information of the object into the compressed bit stream format; and
determining the number of bits to be assigned to each part in a picture of the picture sequence based on light information and the rendering information based on light, encoding of the picture sequence being performed by adaptively applying information generated from converting the contour and scene composition information of the object, generating motion vectors and determining the number of bits to be assigned to each part.
